(19) United States
(12) Patent Application Publication
(10) Pub. No.: US 2019/0225351 A1
(43) Pub. Date: Jul. 25, 2019

(54) METHOD FOR POSITIONING A PASSENGER BOARDING BRIDGE AT AN AIRPLANE

(71) Applicants: THYSSENKRUPP ELEVATOR INNOVATION CENTER S.A., Gijon (ES); thyssenkrupp AG, Essen (DE)

(72) Inventors: Marcos PÉREZ PÉREZ, Oviedo (ES); José MENDIOLAGOITIA JULIANA, Gijón (ES); Joaquín BLANCO FERNÁNDEZ, Gijón (ES); Ignacio ALVAREZ GARCÍA, Gijón (ES)

(73) Assignees: THYSSENKRUPP ELEVATOR INNOVATION CENTER S.A., Gijon (ES); thyssenkrupp AG, Essen (DE)

(21) Appl. No.: 16/301,965

(22) PCT Filed: May 15, 2017
(86) PCT No.: PCT/EP2017/061592

§ 371 Date: Nov. 15, 2018

(30) Foreign Application Priority Data
May 17, 2016 (EP) 16380024.6

(51) Int. Cl. B64F 1/305; G06T 7/73

(52) U.S. Cl. CPC B64F 1/305; G06K 9/00; G06T 7/75

(57) ABSTRACT

A method for positioning a boarding bridge at an airplane includes taking a picture of the parked airplane. A row of two adjacent side window rings is detected in the picture, wherein the side window ring is an extraction of a side window. A door polygon adjacent to the row of side window rings is searched for and a relative position of the door is calculated. The position is compared to a position of a distal end of the passenger boarding bridge or a camera taking the picture and the passenger boarding bridge is moved automatically based on the calculated relative position.

### TECHNICAL FIELD

The invention refers to a method for positioning, in particular docking, a passenger boarding bridge at an airplane.

### TECHNICAL BACKGROUND

Nowadays the docking of a passenger boarding bridge is in main performed by a person, who controls the drive means of the passenger boarding bridge. It a demand to automate this procedure.

EP 2 109 065 B1 discloses in this context system for identifying a type of airplane by optical means. Thereby a nose of the plane is detected and respectively a height of the nose above the ground. By comparing the detected nose height with a known nose height, the type of the airplane can be identified. The system thereby uses a database, in which data of the different types of airplanes are stored.

### SUMMARY OF THE INVENTION

The object of the invention is to provide a universal method for automatically positioning the passenger boarding bridge at an airplane, without the need to retrieve detailed airplane information from a database and in particular without the mediation of a driver.

This object is solved by the method according to claim 1; preferred embodiments are disclosed in the subclaims and the description.

According to the invention a method is claimed for positioning a passenger boarding bridge at an airplane, wherein the passenger boarding bridge comprises a distal end, which is to be aligned with a door of the airplane, the method comprises of the following steps:
taking a picture of the airplane when the airplane is in its parking position;
detecting in the picture a row of at least two window rings, which are, in particular equidistantly, arranged along a line;
searching for a door polygon adjacent to, in particular left or right of, the row of window rings;
assessing, whether the door polygon, found during step of searching, is to be considered as an extraction of the door to be detected;
calculating a relative position of the door, to which the extraction of the door belongs, in particular compared to a position of the distal end of the passenger boarding bridge and/or of the camera(s), wherein the step of calculating is based on the position of the extraction of the door within the picture;
automatically controlling a movement of the passenger boarding bridge based on the calculated relative position in a way, that the distal end of the passenger boarding bridge gets in alignment with the door, to which the detected extraction of the door belongs.

The rings, which can be considered as extracted contours of side windows or a porthole, can have an ellipsoid (including circular) shape or may be shaped as a rectangle having rounded edges.

The surprising result of analyzing multiple types of airplanes was that nearly every commonly used passenger airplane comprises individual geometrical structures on the exterior body, which can be used for locating a door to which a boarding bridge can be docked. Even if these geometrical structures are in detail different for each airplane, these structures are in general present in each individual airplane and comprise some additional regularities, which apply to all common types of passenger airplanes.

It's the same idea as in face recognition; all people in the world have a different face, comprising different combinations of differently shaped noses, eyes, ears, hair, . . . . But nevertheless, each face has a nose, which is located somewhere within a polygon, spanned by the eyes and the mouth of the person.

So during the detection of the position of the door with following geometrical features, which can be extracted from the picture, may be checked:

There may be a porthole ring within the door polygon, wherein in particular the porthole ring is an extraction of a porthole located in the door. Each door comprises a porthole, so that the flight crew can get into eye contact with the ramp agent. This porthole may usually be smaller than the side windows and may be located at above the level of the centerline of the side windows, so that the flight crew member can look through the porthole while standing.

In a first configuration the door polygon may be arranged adjacent to a cockpit window polygon and/or between a cockpit window polygon and the window rings. The cockpit window polygon may be the extraction of a cockpit window at the front of the airplane. Since the cockpit window at the front is smaller than the aircraft door, the door polygon in the picture may be larger than the cockpit window polygon. The cockpit window may be located at a height comparable to the height of the side windows. Thus in the picture the cockpit window polygon may be cut by an elongation of a centerline through the side window rings, which represent the side windows. This configuration is in particular the case for a front door of the airplane. The first side window/window rings may be the front side windows/window rings.

In a second configuration the door polygon may be arranged between a first row of first window rings and a second row of second window rings. This configuration is particular the case during detecting a middle door, arranged in a middle section of the airplane. The second windows/window rings may be middle side windows/window rings. The first side windows/window rings may be the front side windows/window rings.

Calculating the relative position may be supported by an assessment of the curvature of side lines of the door polygon, in particular of an assessment of a convex shape of the side lines. The side lines of the representation of the door appear more convex, the more the camera is offset from the door in a direction longitudinally of the airplane, caused by the circular cross section of the airplane. This knowledge helps to detect the position relative between the camera taking he picture and the door.

The invention refers further to a passenger boarding bridge comprising a control unit configured to perform the method according to any of the preceding claims.

### BRIEF DESCRIPTION OF THE DRAWINGS

The invention is explained in detail with reference to the figures; the figures show:

FIG. 1 a part of a passenger boarding bridge to be attached to an airplane standing in its parking position at an airport;

FIG. 2 a) a front picture of a front airplane,
b) geometric elements extracted from the front picture;

FIG. 3 a) a second picture of a second airplane (with livery),
b) geometric elements extracted from the second picture;

FIG. 4 more extensive geometric elements similar to FIG. 2b.

### DESCRIPTION OF PREFERRED EMBODIMENTS

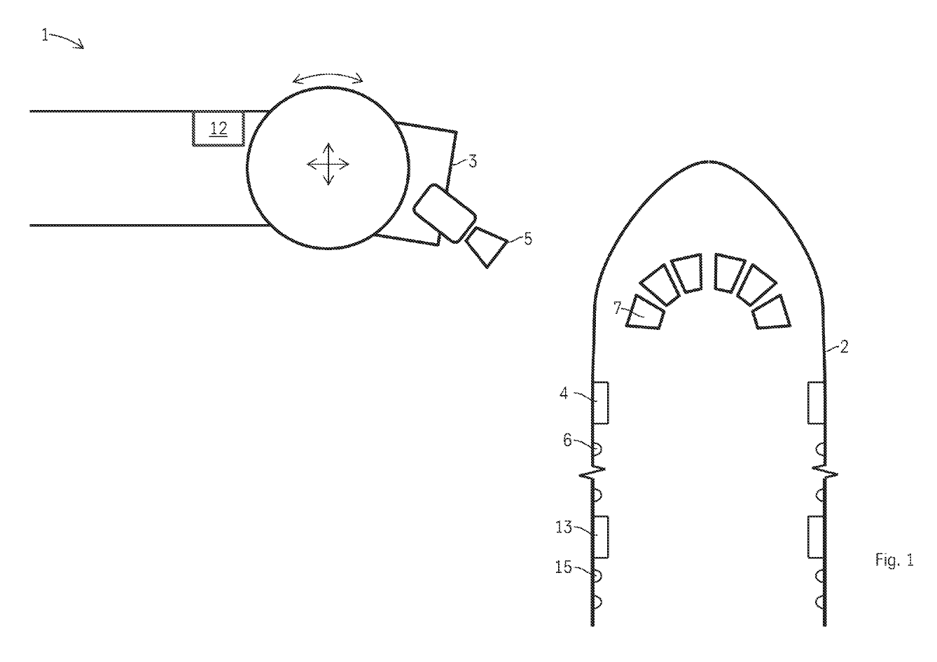

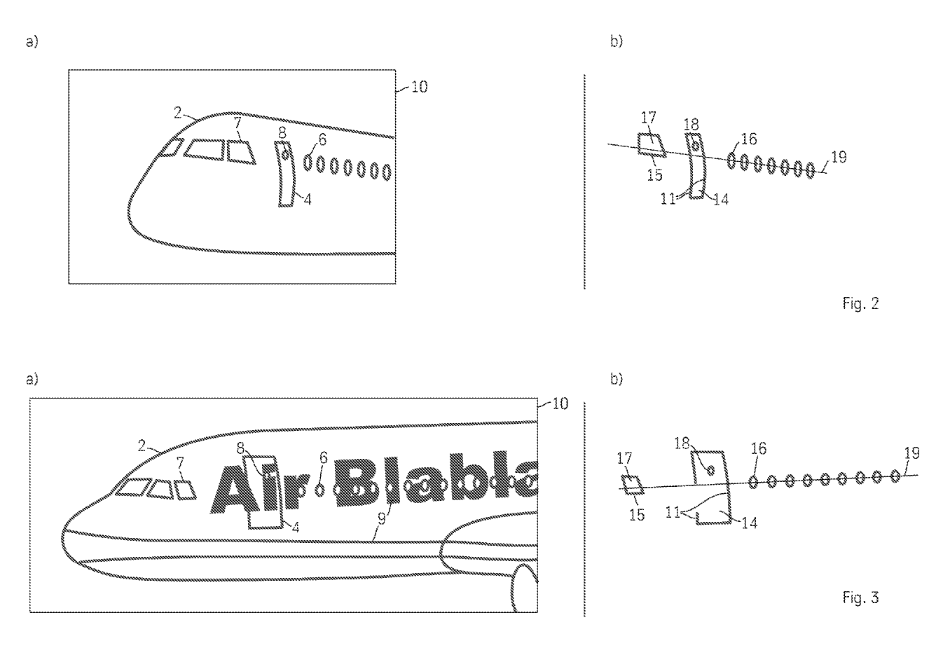

FIG. 1 shows a section of a ramp of an airport, in which an airplane 2 is standing in its parking position. A passenger boarding bridge 1, which is connected to a terminal building, has to be docked to the airplane 2. Therefore a distal end 3 of the passenger boarding bridge 1 needs to be aligned with a front door 4 or middle door 13 of the airplane 2. Conventionally the procedure of aligning is performed by an experienced operator, who controls the drive means of the passenger boarding bridge manually. The present invention comprises a control unit 12 adapted to automatically control the drive means of the passenger boarding bridge, so that no operator is needed anymore.

At the passenger boarding bridge at least one camera 5 (or a set of cameras) is provided which takes at least one picture of the airplane 2. Such pictures 10 are shown for two individual airplanes 2 in FIGS. 2a and 3a.

FIG. 2a shows a picture 10 taken from a front aircraft by the camera 5. This individual aircraft has a blank surface, which is free from ornamental components (no livery). So the front door 4 and several windows, including cockpit windows 7, front side windows 6 and a porthole 8 within the door, are clearly visible.

FIG. 3a shows a picture 10 taken from a second aircraft by the camera 5. This individual second aircraft comprises several ornamental components 9 on its surface (livery), like a broadly written name of the airline and ornamental stripes extending over the entire length of the airplane 2. Parts of the front door 4 and the front side windows 6 are paint over by the ornamental components 9, so that in a front view the front door 4 and the front side windows 6 may not clearly be recognized.

However by using machine vision algorithm for picture analyzing it is possible to extract regular geometric components out of the picture 10, even if they are hidden by the ornamental components 9. As can be seen in FIG. 2b as well as in FIG. 3b it is possible to extract from both pictures a row of front side window rings 16 representing the front side windows 6, arranged regularly along a straight centerline 19, a front door polygon 14 representing the front door 4, a further small porthole ring 18 representing the porthole 8, and a cockpit window polygon 17 representing a cockpit window 7.

A suchlike arrangement of geometric standard objects can be retrieved from nearly every usual standard type of one level passenger airplanes; adaptions may be necessary to detect also airplanes having more than one levels, e.g. the Boeing 747 and the Airbus A380. But also here some regular geometric objects may be available.

So since nearly every usual airplane comprises similar geometric objects, the recognition of airplane structures is similar to recognition of human faces by identifying biometric structures. The picture 10 is thus in a technical way to be considered as a “passport photography” of the airplane. In main by using same techniques as detecting an eye or a mouth of a person in a personal photography, rings and polygon structures on the surface of the airplane can be detected in the present picture 10.

However the present invention is capable to detect a door position without a need of retrieving individual data for different types of airplane from a database. Because if the picture recognition algorithm has detected a door in the picture, there is no need to get additional information, because the door position relative to can then already be calculated based on the position of the door within the pictures. The position of the camera 5 relative to the distal end 3 of the passenger boarding bridge 2 is known, so the relative position between the distal end 3 and the front door 4 can be calculated.

So detecting the position of the front door 4 relative to the distal end of the passenger boarding bridge may be performed by analyzing the picture or a plurality of pictures 10; thereby the front door 4 is always arranged left (when boarding is on the left side as usual) or right (when boarding is on the right side, which is quite unusual) of front side window rings 16, which are regularly arranged along a first centerline 19. The front door 4 is further arranged right of a cockpit window polygon 17 representing the cockpit window 7. The center of the cockpit window polygon 17 is arranged slightly above the first centerline 19 through the front side window rings 16.

The cockpit window polygon 17 is always inclined to the front, when viewed from the lowest line, when the camera 5 is positioned slightly in front of the airplane 2, as shown in FIG. 1. Furthermore the vertical side lines 11 of the front door polygon 14 representing the front door 4 has a slightly convex shape, which is caused by the circular cross section of the body of the airplane 2.

The convex shape of the side lines 11 appears more distinctive in the picture the more the camera 5 is positioned in front of the airplane 2. This is already apparent from a comparison of FIGS. 2b and 3b. Picture 10 of FIG. 2a is taken from a more forward position than picture 10 of picture 3a; thus the curvature of the side lines 11 is in FIG. 2b more distinctive than in FIG. 3b.

Thus the position of the front door 4 can also be detected by assessing the distinction of the convex shape of the side line 11 in the representation 14 of the front door. By evaluating the differences in the convex shape in a series of pictures, taken subsequently during movement of the distal end and of the camera, the detection of the position of the front door 4 can be supported. When the side lines comprise no convex shape at all, then the picture is taken from an exact side view of the respective front door 4.

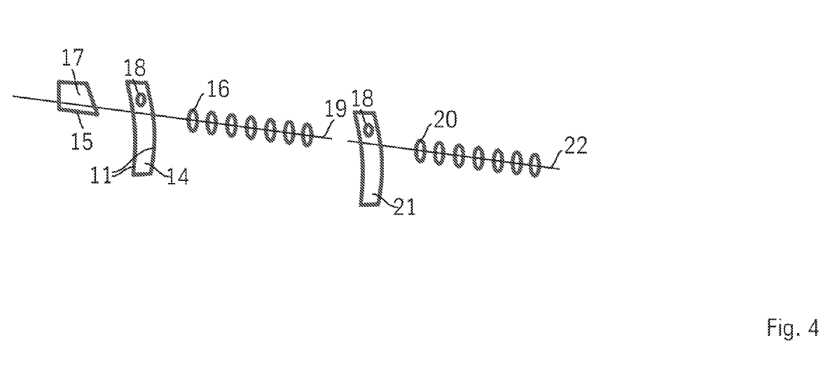

FIG. 4 shows a possibility of detecting the position of the middle door 13, which is located at a middle position of the airplane. In addition to figures previously discussed FIG. 4 shows extractions of the middle door 13 and middle side windows 15 (shown in FIG. 1). In front of the middle door 13, no cockpit window 7 is arranged. Instead the middle door 13 is arranged between front side windows 6 and middle side windows 15. From a respective picture contours can be retrieved, which are shown in FIG. 4. Thus the extractions from the picture comprise a middle door polygon 21 arranged between the first row of front side window rings 16 and a row of middle side windows rings 20, representing the middle side windows 13 and arranged along a second centerline 22. The remaining characteristics relevant to detect the position of the middle door 13 are the same as described with reference to the front door 4.

### LIST OF REFERENCE SIGNS

1 passenger boarding bridge
2 airplane
3 distal end
4 front door
5 camera
6 front side window
7 cockpit window
8 porthole
9 ornamental components
10 picture of airplane
11 side lines
12 control unit
13 middle door
14 extracted contour of front door/front door polygon
15 middle side windows
16 extracted contour of front side window/front side window ring
17 extracted contour of cockpit window/cockpit window polygon
18 extracted contour of porthole/porthole ring
19 first centerline through contours of front side windows
20 extracted contour of middle side window/middle side window ring
21 extracted contour of middle door/middle door polygon
22 second centerline through contours of middle side windows

1.-10. (canceled)

11. A method for positioning a passenger boarding bridge at an airplane, wherein the passenger boarding bridge comprises a distal end, which is to be aligned with a door of the airplane, the method comprising:
taking a picture of the airplane when the airplane is in a parking position;
detecting, in the picture, a row of at least two side window rings, which are arranged along a line, wherein the side window ring is an extraction of a side window;
searching for a door polygon adjacent to the row of side window rings;
assessing whether the door polygon, found during the step of searching, is to be considered as an extraction of a door to be detected;
calculating a relative position of the door, to which the extraction of the door belongs, compared to a position of the distal end of the passenger boarding bridge or compared to a camera taking the picture, wherein the step of calculating is based on the position of the extraction of the door within the picture; and
automatically moving the passenger boarding bridge based on the calculated relative position such that the distal end of the passenger boarding bridge is moved into alignment with the door of the airplane, to which the detected extraction belongs.

12. The method according to claim 11, wherein during the step of assessing it is determined whether a porthole ring is arranged within the door polygon, wherein the porthole ring is an extraction of a porthole located in the door.

13. The method according to claim 12, wherein during the step of assessing it is determined whether the porthole ring is smaller than at least one of the side window rings.

14. The method of claim 12, wherein during the step of assessing it is determined whether the porthole ring is arranged at a higher level than the window rings, wherein the porthole ring is arranged at a higher level if the center of the porthole ring is located above a centerline through the centers of the window rings.

15. The method of claim 11, wherein during the step of assessing it is determined whether a door polygon is arranged adjacent of a cockpit window polygon and/or between a cockpit window polygon and first side window rings, wherein the cockpit window polygon is an extraction of a cockpit window.

16. The method of claim 15, wherein during the step of assessing it is determined whether the door polygon is larger than the cockpit window polygon.

17. The method of claim 15, wherein during the step of assessing it is determined whether the cockpit window polygon is cut by an elongation of a centerline through the centers of the first window rings.

18. The method of claim 12, wherein during the step of assessing it is determined whether the door polygon is arranged between a first row of first window rings and a second row of second window rings.

19. The method of claim 11, wherein the step of calculating is supported by an assessment of the curvature of side lines of the door polygon.

20. A passenger boarding bridge comprising a control unit configured to perform the method of claim 11.

21. The method of claim 11, wherein the at least two side window rings are arranged equidistantly.

22. The method according to claim 12, wherein during the step of assessing it is determined whether the porthole ring is smaller than all of the side window rings.

23. The method of claim 12, wherein during the step of assessing it is determined whether the porthole ring is arranged at a higher level than all of the window rings, wherein the porthole ring is arranged at a higher level if the center of the porthole ring is located above a centerline through the centers of the window rings.

24. The method of claim 11, wherein the step of calculating is supported by an assessment of a convex shape of the side lines.
